(19) United States
(12) Patent Application Publication
(10) Pub. No.: US 2012/0097059 A1
(43) Pub. Date: Apr. 26, 2012

(54) NANOWIRE INK COMPOSITIONS AND PRINTING OF SAME

(75) Inventors: Pierre-Marc Allemand, San Jose, CA (US); Rimple Bhatia, Los Altos, CA (US); Paul Mansky, San Francisco, CA (US)

(73) Assignee: CAMBRIOS TECHNOLOGIES CORPORATION, Sunnyvale, CA (US)

(21) Appl. No.: 13/278,733

(22) Filed: Oct. 21, 2011

Related U.S. Application Data
(60) Provisional application No. 61/406,082, filed on Oct. 22, 2010.
(60) Provisional application No. 61/513,983, filed on Aug. 1, 2011.

(51) Int. Cl. B41F 5/24; C09D 11/02; B82Y 35/00

(52) U.S. Cl. 101/483; 106/31.92; 977/762

(57) ABSTRACT

Described herein are ink compositions suitable for forming conductive films by printing, in particular, by gravure, flexographic, and reverse offset printing.

### CROSS-REFERENCE TO RELATED APPLICATION

This application claims the benefit under 35 U.S.C. §119(e) of U.S. Provisional Patent Application Nos. 61/406,082, filed Oct. 22, 2010, and 61/513,983, filed Aug. 1, 2011, which applications are incorporated herein by reference in their entireties.

### BACKGROUND

1. Technical Field

This disclosure is related to ink compositions comprising metallic conductive nanowires. The ink compositions are suited for printed electronics by gravure, flexographic and offset printing.

2. Description of the Related Art

Printed electronics represents an alternative technology to the conventional chip-based manufacture of electrical or electronic components. Using a solution-based format, printed electronic technology makes it possible to produce robust electronics on large area, flexible substrates. In particular, conventional printing processes such as continuous roll-to-roll printing can be adopted in printed electronics to further reduce manufacturing cost and improve throughput.

Ink compositions comprising conductive nanowires can be coated on a wide range of rigid and flexible substrates to provide transparent conductive thin films or coatings. When suitably patterned, nanowire-based transparent conductors are used as transparent electrodes or thin film transistors in flat panel electrochromic displays such as liquid crystal displays (LCD), plasma displays, touch panels, electroluminescent devices such as organic light emitting diode (OLED), thin film photovoltaic cells (PV), and the like. Other applications of the nanowire-based transparent conductors include anti-static layers and electromagnetic wave shielding layers.

Co-pending and co-owned U.S. patent application Ser. Nos. 11/504,822, 11/766,552, 11/871,767, 11/871,721, 12/380,293, 12/773,734, and 12/380,294 describe various approaches for synthesizing conductive nanowires (e.g., silver nanowires), preparing conductive films via a number of coating or printing methods. These applications are incorporated herein by reference in their entireties.

Depending on the printing methods, nanowire ink compositions are often formulated to address specific requirements such as ink stability and wettability.

### SUMMARY

Described herein are stable liquid formulations (or “ink compositions”) containing silver nanowires and methods of printing the same for providing transparent conductive coatings. These coatings are useful for LCD and plasma displays, as well as organic light emitting diode (OLEDs) and PV devices.

One embodiment provides an aqueous ink composition comprising: a plurality of metal nanostructures, one or more viscosity modifier; and an aqueous liquid carrier including water and one or more water-miscible co-solvents, wherein the water is about 40-60% by weight percentage of the aqueous liquid carrier.

In various embodiments, the aqueous ink composition further comprises one or more surfactants, or one or more adhesion promoters.

In various embodiments, the co-solvent of the aqueous ink composition is methanol, ethanol, n-propanol, i-propanol (IPA), n-butanol, i-butanol, t-butanol, or propylene glycol methyl ether.

In various embodiments, the aqueous ink composition includes water and the co-solvent in a w/w ratio of 1:2, 1:1, 2:1, or in the range from 1:2 to 2:1.

In yet further embodiments, the metal nanostructures are silver nanostructures in ranges of 0.1-1%, 0.1-4%, 0.1-1.5%, or 1-4% by weight percentage of the ink composition.

In other embodiments, the viscosity modifier is hydroxypropylmethylcellulose (HPMC), hydroxypropylcellulose (HPC), methyl cellulose, ethyl cellulose, xanthan gum, polyvinyl alcohol, carboxy methyl cellulose, hydroxy ethyl cellulose, polyvinylpyrrolidone (PVP), or a combination thereof.

In various embodiments, the aqueous ink composition viscosity in the range of 1-1000 cP.

Yet another embodiment provides a method comprising: providing a semi-aqueous ink composition comprising: a plurality of metal nanostructures, one or more viscosity modifiers, and an aqueous liquid carrier, wherein the aqueous liquid carrier includes 40-60% of water; and printing the ink composition by gravure or flexography onto a printing substrate.

A further embodiment provides an organic ink composition, comprising: a plurality of metal nanostructures, one or more viscosity modifiers; and a non-aqueous liquid carrier.

In various embodiments, the non-aqueous liquid carrier comprises a primary organic solvent. In further embodiments, the primary organic solvent is methanol, ethanol, n-propanol, i-propanol (IPA), n-butanol, i-butanol, t-butanol, propylene glycol methyl ether, propylene glycol, or ethylene glycol.

In yet other embodiments, the non-aqueous liquid carrier further comprises an additive having a boiling point of more than 180° C. In further embodiments, the additive is propylene glycol, isophorone, benzyl alcohol, terpineol, N-octylpyrrolidone, or dipropylene glycol methyl ether.

In yet further embodiments, the metal nanostructures are silver nanostructures in ranges of 0.1-1%, 0.1-4%, 0.1-1.5%, or 1-4% by weight percentage of the ink composition.

In other embodiments, the viscosity modifier is hydroxypropyl methylcellulose (HPMC), hydroxypropylcellulose (HPC), methyl cellulose, ethyl cellulose, xanthan gum, polyvinyl alcohol, carboxy methyl cellulose, hydroxy ethyl cellulose, polyvinylpyrrolidone (PVP), or a combination thereof.

A further embodiment provides a method comprising: providing a non-aqueous ink composition comprising: a plurality of metal nanostructures, optionally one or more surfactants, a viscosity modifier, and a non-aqueous liquid carrier; coating the non-aqueous ink composition on a blanket roller; forming a patterned coating layer on the blanket roller by pressing the blanket roller on a patterned printing plate; and transferring the patterned coating layer to a printing substrate.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been selected solely for ease of recognition in the drawings.

FIG. 1 schematically shows reverse offset printing of an ink composition according to an embodiment.

FIGS. 2 and 3 demonstrate a transparent conductive film formed by gravure printing according to an embodiment.

FIG. 4 shows a nanostructure film formed by gravure printing of a semi-aqueous ink composition.

FIGS. 5 and 6 show, as a comparison, gravure printing of 100% aqueous ink composition.

FIG. 7 shows, as a comparison, gravure printing of non-aqueous ink composition.

FIG. 8 shows a patterned transparent conductive film formed by reverse offset printing on a glass substrate according to an embodiment.

FIG. 9 shows a patterned transparent conductive film on a blanket formed by reverse offset printing of an organic ink composition having 2.5% water.

FIG. 10 shows a patterned transparent conductive film on a blanket formed by reverse offset printing of an organic ink composition having 2.5% high-boiling point additive.

### DETAILED DESCRIPTION

Described herein are stable liquid formulations containing silver nanowires and methods of making and printing the same.

### Aqueous or Semi-Aqueous Ink

In certain embodiments, the ink compositions are particularly suited for gravure printing or flexographic printing to provide uniform or patterned conductive films formed from interconnecting metal nanostructures. The ink composition is formulated to provide printed film with electrical conductivity and optical properties (light transmission and haze) that satisfy the product specifications for transparent electrodes in devices such as LCD, OLED and PV cells. Unless specified otherwise, “ink composition,” also referred to as “coating formulations,” “ink” or “ink formulations,” is printable or read-to-print by the printing methods described herein.

In gravure printing, a copper plated ink fountain cylinder is engraved to form an image in intaglio. The intaglio image is defined by cells or wells etched into the cylinder surface. Each cell is sized to contain a predetermined amount of ink. Ink is supplied to the cells by an ink fountain. As the cylinder rotates, the cells are flooded with ink and the surface between cells is wiped clean by a doctor blade. Ink is discharged from each cell and transferred to the smooth surface of an elastomeric blanket secured to a transfer cylinder. The blanket contacts a moving substrate such as a film so as to transfer the inked image to the substrate.

The flexographic printing process provides a simplified ink distribution system. In flexograph printing, an anilox or ink metering cylinder is etched mechanically with cells or wells using a knurled master cylinder. The metering cylinder is flooded with ink at the ink fountain. The cells are sized uniformly so that each contains a predetermined volume of ink. A metered amount of ink is accurately distributed by the cylinder to a flexographic printing plate mounted on a plate cylinder. The printing plate is made of an elastomeric material bearing an image in relief. Successive flexographic stations may be operated to form a design comprising a vignette, or line printing, or combination of both. Ink is deposited on the printing plate at each station by the metering cylinder, and the image is printed on the substrate by the printing plate.

Thus, according to these embodiments, the ink composition comprises a plurality of metal nanostructures, optionally one or more surfactants, one or more viscosity modifiers and an aqueous liquid carrier.

Typically, the aqueous liquid carrier can be a single solvent (i.e., water) or, more typically, a miscible solvent system comprising water and one or more co-solvents.

The co-solvent is miscible with water (hydrophilic) and has a boiling point of no more than 150° C. Preferably, the co-solvent has a boiling point of no more than 120° C. or no more than 100° C. to facilitate drying the ink following printing. In certain embodiments, the co-solvent is an alcohol. Suitable alcoholic co-solvents include, for example, methanol, ethanol, n-propanol, i-propanol (IPA), n-butanol, i-butanol, t-butanol, propylene glycol methyl ether and the like.

In a miscible solvent system, the boiling point is lower than that of each of the pure solvents. Thus, the aqueous liquid carrier has a boiling point of no more than 100° C., the boiling point of water. The low boiling point of the miscible solvent system, and/or the faster evaporation rate of the co-solvent component, allow for rapid curing or drying of the printed film.

In certain embodiments, the water comprises up to 80%, up to 75%, up to 70%, up to 65%, up to 60%, up to 55%, up to 50%, up to 45%, up to 40%, up to 35%, or up to 30% (by weight) of the aqueous solvent system. In certain preferred embodiments, the water and the co-solvent are in a w/w ratio of 1:2, 1:1 and 2:1, or in the range of 1:2 to 2:1.

When the water content is in the range of 40-60% of the total weight of the liquid carrier, the ink composition is also referred to as “semi-aqueous.” In one embodiment, the water content is 50% of the total weight of the liquid carrier. In a preferred embodiment, the aqueous liquid carrier comprises 40-60% of water and the co-solvent is isopropanol.

The metal nanostructures can be prepared according to co-pending, co-owned U.S. patent application Ser. Nos. 11/504,822, 11/766,552, 12/862, 664, and 12/868,511. In certain embodiments, the metal nanostructures comprise silver nanowires (with aspect ratio of more than 10).

In a given printing setting, the amount of the nanostructures in the ink composition generally determines the sheet resistance of the printed film. Typically, the workable range of the sheet resistance for opto-electrical devices (e.g., OLED, PV) is about 20-200 ohms/sq. Thus, in certain embodiments, the silver nanowires are present in the ink composition at an amount of 0.05-5% by weight of the ink composition. In various embodiments, the silver content in the ink composition can be in the range of 0.1-1%, 0.1-4%, 0.1-1.5%, or 1-4%.

The ink composition may further include one or more agents that prevent or reduce aggregation or corrosion of the nanostructures, and/or facilitate the immobilization of the nanostructures on the substrate. These agents are typically non-volatile and include surfactants, viscosity modifiers, corrosion inhibitors, and the like.

In certain embodiments, the ink composition includes one or more surfactants, which serve to adjust the surface tension and wetting. Representative examples of suitable surfactants include fluorosurfactants such as ZONYL® surfactants, including ZONYL® FSN, ZONYL® FSO, ZONYL® FSA, ZONYL® FSH (DuPont Chemicals, Wilmington, Del.), and NOVEC™ (3M, St. Paul, Minn.). Other exemplary surfactants include non-ionic surfactants based on alkylphenol ethoxylates. Preferred surfactants include, for example, octylphenol ethoxylates such as TRITON™ (x100, x114, x45), and secondary alcohol ethoxylates such as TERGITOL™ 15-S series (Dow Chemical Company, Midland Mich.). Further exemplary non-ionic surfactants include acetylenic-based surfactants such as DYNOL® (604, 607) (Air Products and Chemicals, Inc., Allentown, Pa.) and n-dodecyl β-D-maltoside.

In certain embodiments, the ink composition may further include one or more additives that improve the overall performance and stability of the ink composition. For instance, the additives may include adhesion promoters such as organosilanes, including 3-glycidoxypropyltrimethoxysilane, sold as Z-6040 (Dow Corning); antioxidants such as citric acid, gallate esters, tocopherols, and other phenolic antioxidants; UV absorbers such as Uvinul® 3000 (BASF), used alone or in combination with HALS (hindered amines light stabilizers); corrosion inhibitors to protect the metallic nanostructures from corrosion, or a combination thereof. Examples of specific corrosion inhibitors are described in co-pending U.S. application Ser. No. 11/504,822.

In certain embodiments, the ink composition includes one or more viscosity modifiers, which serve as a binder material that immobilizes the nanostructures on a substrate. Examples of suitable viscosity modifiers include hydroxypropyl methylcellulose (HPMC), hydroxypropylcellulose (HPC), methyl cellulose, ethyl cellulose, xanthan gum, polyvinyl alcohol, polyvinylpyrrolidone (PVP), carboxy methyl cellulose, and hydroxy ethyl cellulose.

The amount of the viscosity modifier may be adjusted to achieve a final ink viscosity suitable for a given printing method. For gravure printing, the preferred viscosity range for the ink composition is in the range of 1-1000 cP. In certain embodiments, the viscosity is less than 100 cP. In other embodiments, the ink composition has a viscosity in the range of 500-1000 cP. In yet other embodiments, the viscosity is in the range of 650-750 cP.

For flexographic printing, the ink composition may have a viscosity less than 100 cP, and preferably, less than 30 cP.

In particular embodiments, the ratio of the surfactant to the viscosity modifier is preferably in the range of about 80 to about 0.01; the ratio of the viscosity modifier to the metal nanowires is preferably in the range of about 5 to about 0.000625; and the ratio of the metal nanowires to the surfactant is preferably in the range of about 560 to about 5. The ratios of components of the ink composition may be modified depending on the substrate and the printing methods.

In a preferred embodiment, the printable ink composition comprises 0.4% silver nanowires, 0.2% of HPMC, and 125 ppm of surfactant, in a water and isopropanol (1:1) miscible solvent system. The ink composition has a viscosity of about 17 cP.

A further embodiment provides a method of printing an aqueous ink composition, as described herein. The printing method may be gravure or flexographic.

In certain embodiments, a semi-aqueous ink composition is better suited for gravure or flexographic printing than an ink composition that is solely water-based or solely organic solvent-based.

Thus, one embodiment provides a method comprising: providing a semi-aqueous ink composition having: a plurality of metal nanostructures, optionally one or more surfactants, a viscosity modifier; and an aqueous liquid carrier, wherein the aqueous liquid carrier includes 40-60% of water; and printing the ink composition by gravure or flexography onto a printing substrate.

In a further embodiment, the printing comprises printing according to a pattern.

### Organic Ink Compositions

In other embodiments, the ink composition is non-aqueous and comprises one or more organic solvents. Although the organic formulations are also suitable for gravure or flexographic printing, they are particularly suited for reverse offset printing.

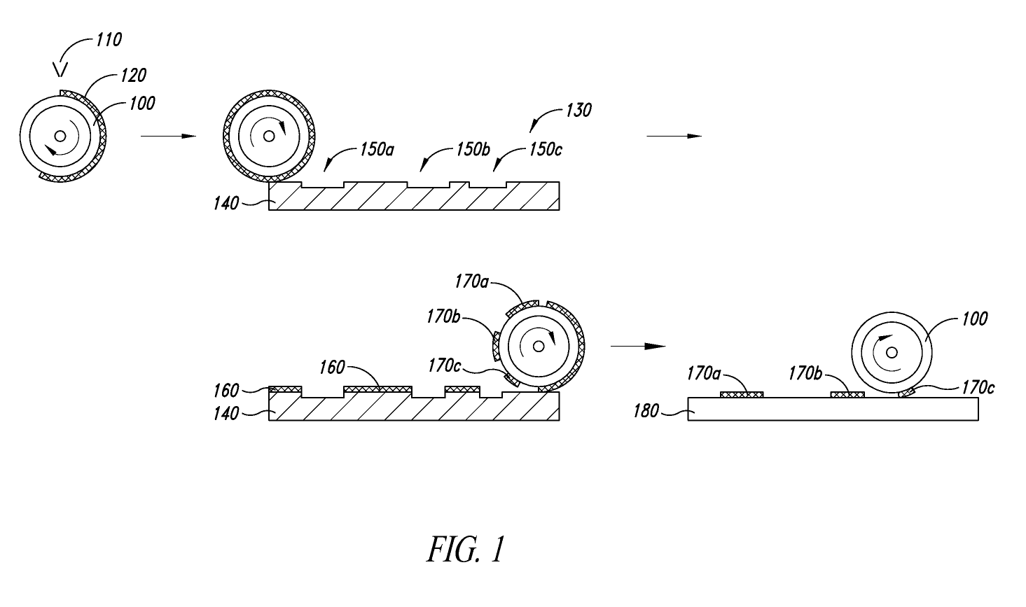

In reverse offset printing (shown in FIG. 1), the ink composition is first coated on a blanket roll (100) through a slit die (110) for forming a uniform coating (120). The coating is allowed to partially dry between about 0 to 60 seconds. The blanket roll (100) is then pressed against a cliché (130), also referred to as a “printing plate.” The printing plate includes a plate (140) with patterned features, shown as etched depths (150a, 150b, 150c). The depth is generally less than 100 μm, 70 μm or less, or 20 μm or less. Typically, the printing plate is made of metal, ceramic, glass, or polymeric materials. As the blanket roll (100) is pressed against the cliché (130), unwanted ink (160) adheres to the cliché, whereas ink that remains on the blanket creates a pattern (170a, 170b, 170c), which correspond to the pattern set by the cliché (150a, 150b, 150c, respectively). Thereafter, the blanket roll (100) is pressed against a printing substrate (180) to transfer the desired pattern (170a, 170b, 170c) to the printing substrate.

According to these embodiments, the ink composition suitable for reverse offset printing comprises a plurality of metal nanostructures, optionally one or more surfactants, one or more viscosity modifiers, and a non-aqueous liquid carrier.

In a further embodiment, the non-aqueous liquid carrier comprises a primary organic solvent, including, for example, methanol, ethanol, n-propanol, i-propanol, n-butanol, i-butanol, t-butanol, propylene glycol monomethyl ether (PGME), and polyols such as ethylene glycol. Typically, the primary organic solvent has a boiling point of no more than 170° C., or more typically, no more than 150° C., or even more typically, no more than 100° C. A preferred primary organic solvent is isopropanol. Another preferred primary organic solvent is ethanol.

In certain embodiments, the non-aqueous liquid carrier may further comprise one or more organic, high boiling point additive. The additive typically has a boiling point of more than 170° C., or more typically, more than 180° C., or more than 200° C. The high-boiling point additive, although present in a small amount (less than 5%, or more typically, less than 2%), may play a significant role in controlling the drying or curing speed, which in turn affects the final film quality. Examples of the primary organic solvent and additives, as well as their boiling points, are listed in Table 1.

In preferred embodiments, the high boiling point additives include propylene glycol (PG), isophorone, benzyl alcohol, terpineol, N-octylpyrrolidone, or dipropylene glycol methyl ether (DPM).

TABLE 1

| | Boiling Point |
|---|---|
| Solvent | (° C.) |
| Acetone | 56 |
| Methanol | 65 |
| Ethanol | 78 |
| Isopropanol | 82 |
| Propylene glycol methyl ether | 115 |
| Butanol | 118 |
| Methyl 3-methoxypropionate | 142 |
| Propylene glycol methyl ether acetate | 146 |
| Ethyl lactate | 154 |
| Ethyl ethoxy propionate | 166 |
| Diacetone alcohol | 166 |
| Butoxyethanol | 168 |
| Propylene glycol | 188 |
| Dipropylene glycol methyl ether | 190 |
| N-methyl-2-pyrrolidone | 202 |
| γ-Butyrolactone | 204 |
| Benzyl alcohol | 205 |
| Terpineol | 219 |
| Isophorone | 215 |

As in the aqueous ink composition, the non-aqueous ink composition may optionally comprise one or more surfactants. Examples of surfactants are described herein.

As in the aqueous ink composition, the non-aqueous ink composition may optionally comprise additional additives, include adhesion promoters such as organosilanes, e.g., 3-glycidoxypropyltrimethoxysilane, sold as Z-6040 (Dow Corning); antioxidants such as citric acid, gallate esters, tocopherols, and other phenolic antioxidants; UV absorbers such as Uvinul® 3000 (BASF), used alone or in combination with HALS (hindered amines light stabilizers); corrosion inhibitors to protect the metallic nanostructures from corrosion, or a combination thereof.

In addition, one or more viscosity modifiers are present in the non-aqueous ink composition, according to one embodiment. Examples of viscosity modifiers are described herein. In a preferred embodiment, the viscosity modifier is hydroxypropylcellulose (HPC). In another embodiment, the viscosity modifier is polyvinylpyrrolidone (PVP).

The viscosity of the non-aqueous ink composition for reverse offset printing is typically 50 cP or less. More typically, the viscosity of the non-aqueous ink composition is less than 20 cP, or more typically, less than 10 cP. In certain embodiments, the viscosity is in the range of 5-10 cP. In other embodiments, the viscosity is in the range of 1-5 cP.

In certain embodiments, the silver nanowires are present in the non-aqueous ink composition at an amount of 0.05-5% by weight of the ink composition. In various embodiments, the silver content in the ink composition can be in the range of 0.1-1%, 0.1-4%, 0.1-1.5%, or 1-4%.

Table 2 shows, according to various embodiments, organic ink compositions suitable for reverse offset printing to provide a transparent conductive film. Each component is shown in respective weight percentage of the total weight of the ink composition. The viscosity modifier is polyvinylpyrrolidone (PVP).

TABLE 2

| | Silver | Viscosity | High Boiling Point | Primary |
|---|---|---|---|---|
| | Nanostructures | Modifier (PVP) | Additive | Organic |
| Ink | (%) | (%) | (1.0%) | Solvent |
| 1 | 0.5 | 0.5 | none | IPA |
| 2 | 0.5 | 1.0 | none | IPA |
| 3 | 0.5 | 1.0 | Isophorone | IPA |
| 4 | 0.5 | 1.0 | Benzyl alcohol | IPA |
| 5 | 0.5 | 1.0 | terpineol | IPA |
| 6 | 0.5 | 1.0 | N-octylpyrrolidone | IPA |
| 7 | 0.5 | 1.0 | DPM | IPA |
| 8 | 0.5 | 1.0 | PG | IPA |
| 9 | 0.4 | 0.8 | PG | IPA |
| 10 | 0.25 | 0.5 | PG | IPA |
| 11 | 0.5 | 1.0 | Benzyl alcohol | Ethanol |
| 12 | 0.5 | 1.0 | terpineol | Ethanol |
| 13 | 0.5 | 1.0 | DPM | Ethanol |
| 14 | 0.5 | 1.0 | PG | Ethanol |

A further embodiment provides a method of printing a non-aqueous ink composition, as described herein. The printing method may be gravure, flexographic, or offset printing.

A preferred embodiment provides a method of reverse offset printing using the non-aqueous ink composition described herein. More specifically, the method includes providing a non-aqueous ink composition comprising: a plurality of metal nanostructures, optionally one or more surfactants, a viscosity modifier, and a non-aqueous liquid carrier; coating the non-aqueous ink composition on a blanket roller; forming a patterned coating layer on the blanket roller by pressing the blanket roller on a patterned printing plate; and transferring the patterned coating layer to a printing substrate.

### Printing Substrate

The printing substrate can be rigid or flexible. Preferably, the substrate is also optically clear, i.e., light transmission of the material is at least 80% in the visible region (400 nm -700 nm).

Examples of flexible substrates include, but are not limited to: polyesters (e.g., polyethylene terephthalate (PET), polyester naphthalate, and polycarbonate), polyolefins (e.g., linear, branched, and cyclic polyolefins), polyvinyls (e.g., polyvinyl chloride, polyvinylidene chloride, polyvinyl acetals, polystyrene, polyacrylates, and the like), cellulose ester bases (e.g., cellulose triacetate, and cellulose acetate), polysulphones such as polyethersulphone, polyimides, silicones, and other conventional polymeric films.

Examples of rigid substrates include glass, polycarbonates, acrylics, and the like. In particular, specialty glass such as alkali-free glass (e.g., borosilicate), low alkali glass, and zero-expansion glass-ceramic can be used. The specialty glass is particularly suited for thin panel display systems, including Liquid Crystal Display (LCD).

The printing substrate may be surface treated prior to printing in order to improve wettability and ink adhesion.

The various embodiments described herein are further illustrated by the following non-limiting examples.

### Example 1

A semi-aqueous formulation was prepared by combining a silver nanostructures suspension in water, a stock solution of a water-soluble viscosity modifier (e.g., HPMC), a non-ionic surfactant Triton X100, and a water-miscible organic solvent isopropanol at the following respective weight percentages:

0.4% silver nanostructures

0.2% HPMC

125 ppm TRITON X100

50% Water

50% IPA

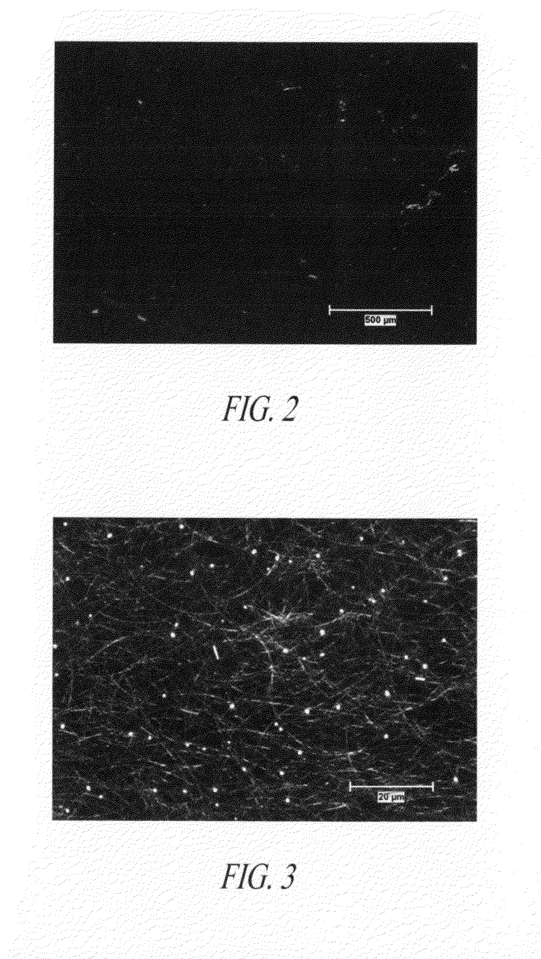

This formulation was coated on a flexible PET film with a tabletop gravure printing machine (K Printing Proofer available from RK Print-Coat Instruments Ltd. in Herts, United Kingdom). The printed film had a conductivity of about 20 ohms/sq, a transmission of about 97%, a haze of about 2%, and showed good uniformity, as shown in FIG. 2 (5× magnification) and FIG. 3 (100× magnification).

### Example 2

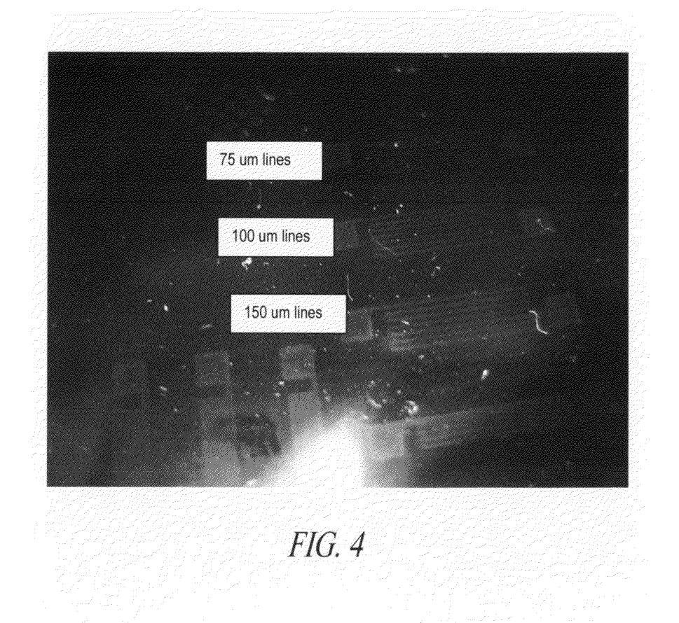

The same semi-aqueous formulation of Example 1 was coated on a flexible PET film with a tabletop gravure printing machine. A patterned cliché having small features was used. The printed features were not conductive but showed good printability, as shown in FIG. 4. This demonstrates that the semi-aqueous formulation is adequate for gravure printing.

The following comparative examples show that, for gravure printing, a semi-aqueous ink composition can provide a more uniform and stable conductive film as compared to a 100% water-based ink or an organic, non-aqueous ink.

### Comparative Example 1

An aqueous formulation was made by combining a suspension of silver nanostructures in water, a stock solution of a water-soluble polymer hydroxypropylmethylcellulose (HPMC), and a non-ionic surfactant Triton X100, at the following respective weight percentages:

0.4% silver nanowires

0.4% HPMC

250 ppm Triton X100

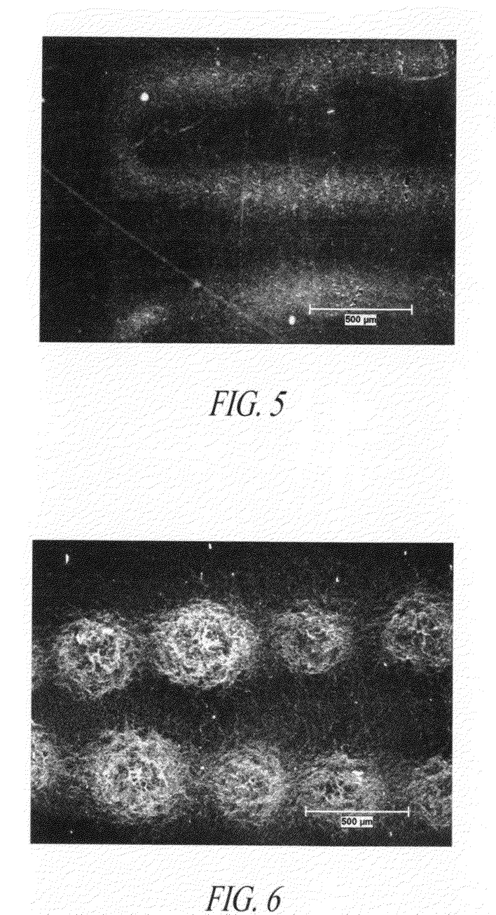

This formulation was coated on a flexible PET film with a tabletop gravure printing machine. The printed film was not conductive and showed rib-like features shown in FIG. 5 (at 5× magnification).

### Comparative Example 2

An aqueous formulation was made by combining a silver nanowires suspension in water and additional water so that the final ink composition comprised 2.5% silver nanowires.

This formulation was coated on a flexible PET film with a tabletop gravure printing machine. The printed film was conductive, but showed dot-like features shown in FIG. 6 (at 5× magnification)

### Comparative Example 3

An organic formulation was made by suspending silver nanowires in propylene glycol so that the final composition comprised 3% silver nanowires.

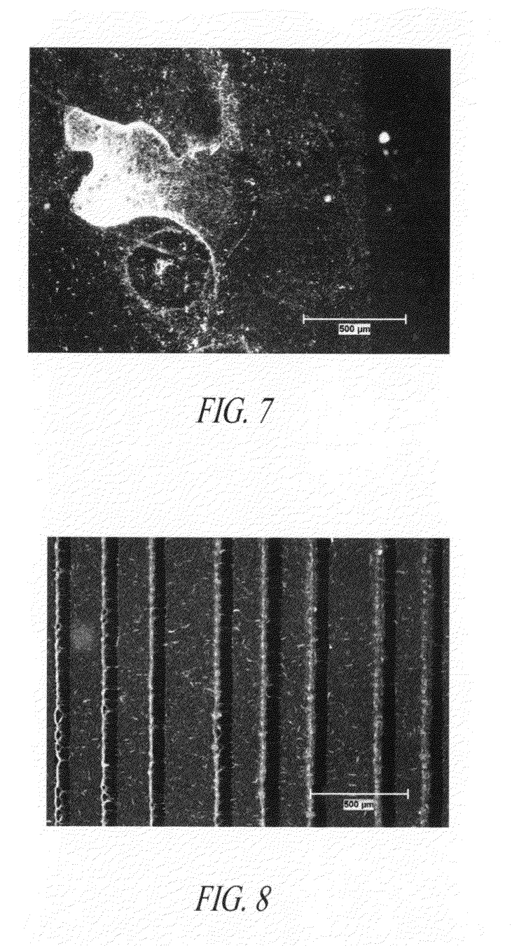

This formulation was coated on a flexible PET film with a tabletop gravure printing machine. The printed film was not conductive and showed non-uniformities, see, FIG. 7 (at 5× magnification).

### Example 3

A non-aqueous, organic formulation was prepared by combining a suspension of silver nanostructures in ethanol with a stock solution of hydroxypropylcellulose (HPC) in ethanol, so that the final composition comprised: 0.2% silver nanostructures and 0.4% HPC.

This formulation was manually rod coated on flexible polydimethylsiloxane (PDMS) printing blankets. The coated film was reasonably uniform but showed some dewetting features on certain grade of blanket material.

### Example 4

The same ethanol-based formulation of Example 3 was rod coated on a PDMS blanket. The wet film dried in about 1 minute. Before the drying was completed, the film was patterned by pressing the blanket roller on a patterned printing plate. Thereafter, the patterned film was mechanically transferred from the blanket to a glass substrate by applying moderate pressure, manually. The glass substrate showed the transferred silver nanostructures in a pattern (FIG. 8).

### Example 5

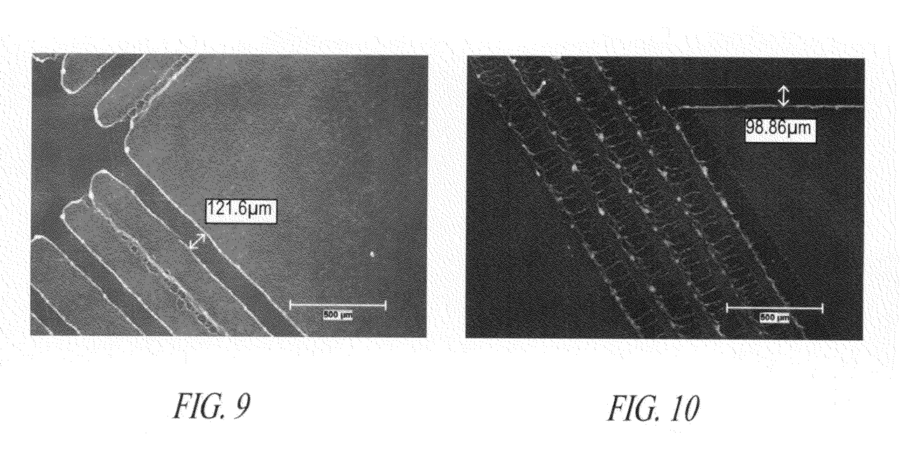

To the same ethanol-based formulation of Example 3 was added about 2-3% of additives, including, water, PGME or a higher boiling point solvent such as PG, in order to control the drying speed of the initial coating on the blanket. FIG. 9 shows a patterned film formed from an ink composition of Example 3 with 2.5% water added. FIG. 10 shows a patterned film formed from an ink composition of Example 3 with 2.5% PGME added. Both Figures are at 5× magnification and are showing the patterned film on the PDMS blanket. As shown, depending on the nature and boiling point of the additives, the drying speed may vary.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An ink composition comprising:
a plurality of metal nanostructures,
one or more viscosity modifier; and
an aqueous liquid carrier including water and one or more water-miscible co-solvents, wherein the water is about 40-60% by weight percentage of the aqueous liquid carrier.

2. The ink composition of claim 1 further comprising one or more surfactants.

3. The ink composition of claim 1 further comprising an adhesion promoter.

4. The ink composition of claim 3 wherein the adhesion promoter is a organosilane compound.

5. The ink composition of claim 1 wherein the co-solvent is methanol, ethanol, n-propanol, i-propanol (IPA), n-butanol, i-butanol, t-butanol, propylene glycol, propylene glycol methyl ether, or ethylene glycol.

6. The ink composition of claim 1 wherein the water and the co-solvent are in a w/w ratio of 1:2, 1:1, 2:1, or in the range from 1:2 to 2:1.

7. The ink composition of claim 1 wherein the metal nanostructures are silver nanostructures in ranges of 0.1-1%, 0.1-4%, 0.1-1.5%, or 1-4% by weight percentage of the ink composition.

8. The ink composition of claim 1 wherein the viscosity modifier is hydroxypropyl methylcellulose (HPMC), hydroxypropylcellulose (HPC), methyl cellulose, ethyl cellulose, xanthan gum, polyvinyl alcohol, carboxy methyl cellulose, hydroxy ethyl cellulose, polyvinylpyrrolidone (PVP), or a combination thereof.

9. The ink composition of claim 1 having a viscosity in the range of 1-1000 cP.

10. A method, comprising:
providing a semi-aqueous ink composition comprising: a plurality of metal nanostructures, one or more viscosity modifiers, and an aqueous liquid carrier, wherein the aqueous liquid carrier includes 40-60% of water; and
printing the ink composition by gravure or flexography onto a printing substrate.

11. The method of claim 10 wherein printing comprises printing according to a pattern.

12. An ink composition, comprising:
a plurality of metal nanostructures;
one or more viscosity modifiers; and
a non-aqueous liquid carrier.

13. The ink composition of claim 12 wherein the non-aqueous liquid carrier comprises a primary organic solvent.

14. The ink composition of claim 13 wherein the primary organic solvent is methanol, ethanol, n-propanol, i-propanol (IPA), n-butanol, i-butanol, t-butanol, propylene glycol methyl ether, propylene glycol, or ethylene glycol.

15. The ink composition of claim 13 wherein the non-aqueous liquid carrier further comprises an additive having a boiling point of more than 180° C.

16. The ink composition of claim 15 wherein the additive is propylene glycol, isophorone, benzyl alcohol, terpineol, N-octylpyrrolidone, or dipropylene glycol methyl ether.

17. The ink composition of claim 12 wherein the metal nanostructures are silver nanostructures in ranges of 0.1-1%, 0.1-4%, 0.1-1.5%, or 1-4% by weight percentage of the ink composition.

18. The ink composition of claim 12 wherein the viscosity modifier is hydroxypropyl methylcellulose (HPMC), hydroxypropylcellulose (HPC), methyl cellulose, ethyl cellulose, xanthan gum, polyvinyl alcohol, carboxy methyl cellulose, hydroxy ethyl cellulose, polyvinylpyrrolidone (PVP), or a combination thereof.

19. A method, comprising:
providing a non-aqueous ink composition comprising: a plurality of metal nanostructures, optionally one or more surfactants, a viscosity modifier, and a non-aqueous liquid carrier;
coating the non-aqueous ink composition on a blanket roller;
forming a patterned coating layer on the blanket roller by pressing the blanket roller on a patterned printing plate; and
transferring the patterned coating layer to a printing substrate.

20. The method of claim 19 wherein the non-aqueous ink composition comprises a primary organic solvent and an additive having a boiling point of more than 180° C.
